(19) United States
(12) Patent Application Publication
(10) Pub. No.: US 2008/0092445 A1
(43) Pub. Date: Apr. 24, 2008

(54) SELF CLOSING DRIVE-THRU WINDOW ASSEMBLY

(75) Inventor: Manuel Ramirez, Aurora, IL (US)

Correspondence Address: BANNER & WITCOFF, LTD., TEN SOUTH WACKER DRIVE, SUITE 3000, CHICAGO, IL, 60606, US

(73) Assignee: READY ACCESS, INC., West Chicago, IL (US)

(21) Appl. No.: 11/551,875

(22) Filed: Oct. 23, 2006

(51) Int. Cl. E05D 15/06

(52) U.S. Cl. 49/231

(57) ABSTRACT

A service window assembly includes a window frame and a door slidably mounted within the frame. The door is moveable between an open position and a closed position and is biased toward the closed position. A magnet is connected to one of the frame and the door and is operable in an active state and an inactive state, and a magnetic contact is connected to the other of the frame and the door. The magnetic contact is located proximate the magnet when the door is in the open position, and when the magnet is in the active state, the magnet and the magnetic contact form a magnetic connection, securing the door in the open position. A sensor monitors the presence of a user. The sensor is in communication with the magnet, so that the magnet is in the active state when the sensor detects that the user is present, and the magnet is in the inactive state when the sensor detects that the user is not present.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to window assemblies, and more particularly to self-closing, manual-open, electronic-release window assemblies for service applications.

### BACKGROUND OF THE INVENTION

Window assemblies for use in service applications are known in the art. However, prior window assemblies present particular drawbacks and disadvantages. The present invention is provided to solve these problems, and to provide advantages and aspects not provided by prior window assemblies of this type. A full discussion of the features and advantages of the present invention is deferred to the following detailed description, which proceeds with reference to the accompanying drawings.

### SUMMARY OF THE INVENTION

A service window assembly includes a window frame and a door slidably mounted within the frame. The door is moveable between an open position and a closed position. A magnet is connected to one of the frame and the door and is operable between an active state and an inactive state, and a magnetic contact is connected to the other of the frame and the door. The magnetic contact is located proximate the magnet when the door is in the open position, and when the magnet is in the active state and the door is in the open position, the magnet and the magnetic contact form a magnetic connection, securing the door in the open position.

According to one aspect of the invention, a sensor monitors the presence of a user. The sensor is in communication with the magnet, so that the magnet is in the active state when the sensor detects that the user is present, and the magnet is in the inactive state when the sensor detects that the user is not present.

According to another aspect of the invention, a second door is slidably mounted within the frame in side-by-side relation with the first door. The second door is also moveable between an open position and a closed position, and the first door and the second door move in opposing directions between the respective open and closed positions.

According to another aspect of the invention, an inclined track is attached to the frame, including a first arm and a second arm extending in opposite directions from a center point. The first door is coupled to the first arm by a first roller assembly and the second door is coupled to the second arm by a second roller assembly. The first arm and second arm are inclined downwardly toward the center point to gravitationally bias the first door and the second door toward the closed positions.

According to another aspect of the invention, a pulley assembly operably connects the first door and the second door. The pulley assembly moves the first door and the second door in unison between the respective open and closed positions.

According to another aspect of the invention, a sensor is connected to the window assembly to monitor the presence of a user. The sensor is in communication with the magnet, so that the magnet is in the active state when the sensor detects that the user is present, and the magnet is in the inactive state when the sensor detects that the user is not present.

According to another aspect of the invention, a controller is provided in communication with the magnet and the sensor. The controller controls the magnet to the active state when the sensor detects that the user is present, and the controller controls the magnet to the inactive state when the sensor detects that the user is not present.

According to another aspect of the invention, a power source is in electrical connection with the magnet. The controller controls electrical current from the power source to the magnet to control the magnet between the active state and the inactive state.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a front view of a window assembly of the present invention;

FIG. 2 is a partially-revealed front view of a window assembly of the present invention, having two doors in closed positions;

FIG. 3 is a partially-revealed front view of the window assembly of FIG. 2, with the doors in open positions;

FIG. 4 is a focused front view of a portion of the window assembly of FIG. 2;

FIG. 5 is a focused front view of a portion of the window assembly of FIG. 2;

FIG. 6 is a schematic view of a sensor, a magnet, a controller, and a power source of a window assembly of the present invention;

FIG. 7 is a partially-revealed front view of another embodiment of a window assembly of the present invention, having a single door proximate a closed position; and

FIG. 8 is a partially-revealed front view of the window assembly of FIG. 7, with the door in an open position.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

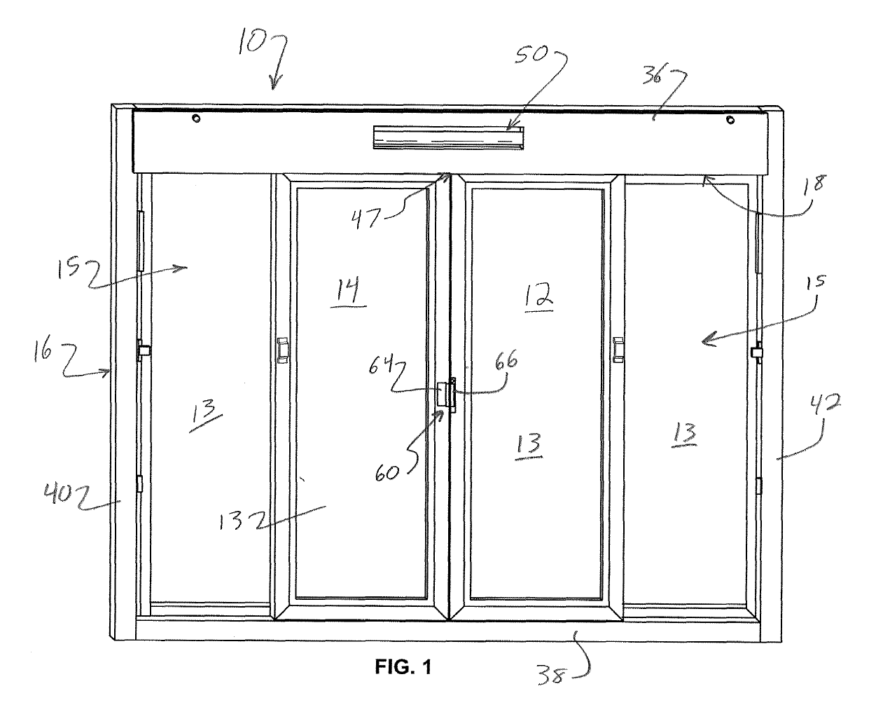

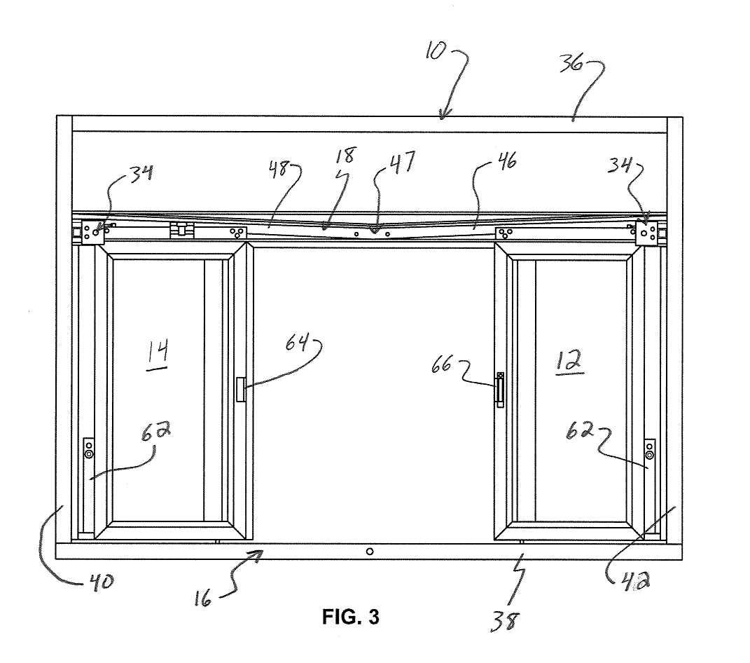

Referring now to the Figures, and specifically to FIGS. 1-3, there is shown a service window assembly 10. The service window assembly 10 generally includes a first door 12 and a second door 14, a window frame 16 for supporting the doors 12,14, and a track 18 attached to the window frame 16. The doors 12,14 are slidably mounted on the track 18 and are each moveable between an open position (FIG. 3) and a closed position (FIG. 1). The window assembly 10 also includes magnet assembly 20 to maintain the first door 12 in an open position and a sensor 50 for detecting the presence of a user.

The window frame 16 is adapted to be mounted inside a wall, allowing the window assembly 10 to provide access to the exterior of a building or another room within the building. The window frame 16 includes a top member 36, a bottom member 38, and two side members 40,42. The side members 40,42 extend between the top member 36 and the bottom member 38 at opposing ends of the top and bottom members 36,38.

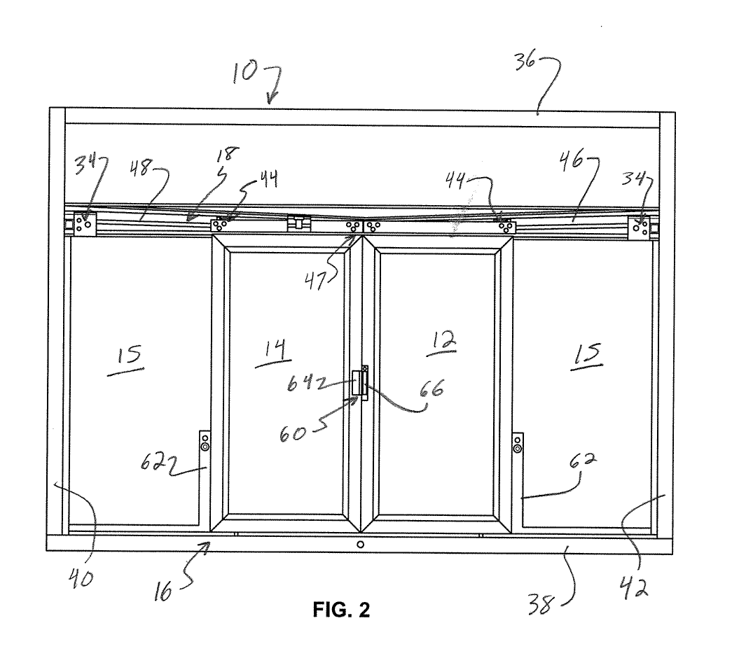

The doors 12,14 are mounted on the track 18 in side-by-side arrangement, as illustrated in FIGS. 1-3. In the embodiment shown, the first door 12 and the second door 14 move in opposing directions between their respective open and closed positions. FIGS. 1 and 2 illustrate the doors 12,14 both in the closed positions, and the doors 12,14 meet proximate the center point 47 of the track 18. FIGS. 3 and 5 illustrate the movement of the doors 12,14 to the open positions. Each door 12,14 preferably holds a pane 13 of glass, permitting visibility through the doors 12,14. Additionally, fixed panels 15 are positioned within the frame on the sides of the doors 12,14 to seal the window assembly 10. These fixed panels 15 also preferably each hold a glass pane 13 for visibility purposes. The doors 12,14 pass by the fixed panels 15 in parallel relation thereto when the doors 12,14 are opened and closed.

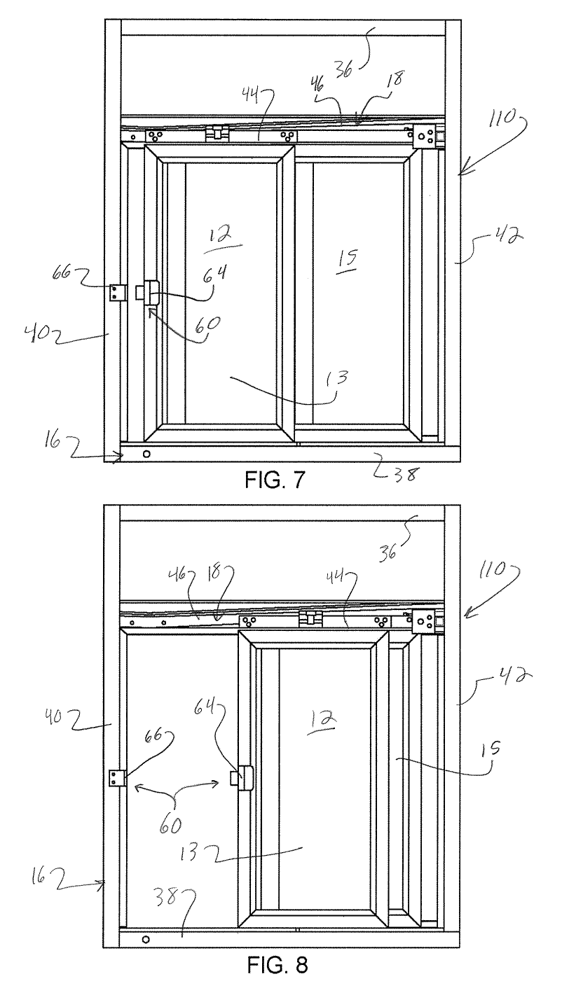

In other embodiments, the doors 12,14 may be mounted differently, and may be mounted in a swinging arrangement rather than a sliding arrangement. In one alternate embodiment, described below and shown in FIGS. 7-8, the window assembly 10 has only a single door 12, rather than two doors 12,14. Other components of this single-door 12 window assembly 110 are similar to those described herein with respect to the two-door 12,14 window assembly 10, and are consistently identified by the same reference numerals. The magnet 22 and the magnet contact 24 can be positioned in the same configuration relative to the first door 12 on the two-door assembly 10. The door 12 is illustrated in the open position in FIG. 8, and in approximately the closed position in FIG. 7. It is understood that certain components of the single-door assembly 110 are different in form and/or function than those components of the two-door assembly 10, and that some components may be absent, due to the nature of the single-door assembly 110. For example, the single-door assembly 110 will have a track 18 having only a single inclined arm 46 that is inclined toward the side member 40 of the frame 16, rather than toward a center point 47 as in the two-door assembly 10. Thus, in the single-door assembly 110, the closed position of the door 12 is resting against the side member 40, rather than a second door. Additionally, no pulley assembly is necessary in the single-door assembly 10. Further differences between the two embodiments 10,110 are readily apparent to one skilled in the art. A more detailed example of such a single-door window assembly is shown in U.S. Pat. No. 5,970,657, which is incorporated by reference herein and made part hereof.

The track 18 is mounted to the window frame 16 the top section 36 of the window frame 16, and the doors 14,16 are slidably mounted on the track 18 by roller assemblies 44. In one embodiment, the track 18 is C-shaped or G-shaped in cross section, and the roller assembly 44 includes one or more rollers (not shown) that ride within the track 18. Still further, the track 18 may contain two members extending along parallel planes, and the roller assembly 44 may have rollers that ride within each track member. As shown in FIGS. 2 and 3, the track 18 may be mounted at an inclined angle, biasing the doors 12,14 to the closed position. In the embodiment shown in FIGS. 2 and 3, the track 18 includes a first arm 46 and a second arm 48 extending in opposite directions from a center point 47. The first door 12 is coupled to the first arm 46 by a first roller assembly 44 and the second door 14 is coupled to the second arm 48 by the second roller assembly 44. The first arm 46 and second arm 48 are each inclined downwardly toward the center point 47 to gravitationally bias the doors 12,14 toward the center point 47, and thus, toward the closed positions. The downwardly-angled arms 46,48 cause the track 18 shown in FIGS. 2 and 3 to exhibit a “V-shape” . An example of a suitable track 18 and roller assembly 44 is shown and described in greater detail in U.S. Pat. No. 5,970,657, which is incorporated by reference herein and made part hereof. Because the doors 12,14 are biased toward the closed positions, the doors 12,14 will close automatically, unless restrained by a greater force. In the single-door embodiment, the entire track may be inclined downward toward an end of the track, rather than a center point, allowing the single door to close against the edge of the window frame.

The track 18 shown in FIGS. 2-5 is adjustable to control the incline of each arm 46,48, which in turn controls the biasing force biasing the doors 12,14 toward the closed positions. In one embodiment, each arm 46,48 has an adjustment screw (not shown) at the distal end opposite the center point 47, and the height of the distal end of each arm can be adjusted by turning the screw in an appropriate direction. In other embodiments, the track 18 may be adjustable by a different manual or automatic adjustment mechanism. The track 18 of the single-door embodiment may be adjustable in the same manner as described above.

In one preferred embodiment, the doors 12,14 are operably connected to each other such that the first door 12 and the second door 14 move in unison between the respective open and closed positions. In the embodiment shown in FIGS. 2 and 3, a pulley assembly 34 operably connects the first door 12 and the second door 14 to move the first door 12 and the second door 14 in unison between the respective open and closed positions. When one of the first door 12 and the second door 14 is pulled open, such as by a user, the pulley assembly 34 operates to pull open the other of the first door 12 and the second door 14. The pulley assembly 34 also operates to hold one door 12,14 in the open position when the other door 12,14 is held open by a direct force. The gravitational bias imparted by the inclined track 18 returns the doors 12,14 to the closed positions. In other embodiments, a different mechanism may be used to operably connect the doors 12,14. For example, in one embodiment, the doors 12,14 may be opened and/or closed by an automated electrical or mechanical mechanism.

The window assembly 10 shown in FIGS. 1-3 has a latch 60 for locking the first and second doors 12,14 together and lock bars 62 for bracing each of the doors 12,14 in the closed position. In the embodiment shown in FIG. 1, the latch 60 includes a locking member 64 located on one of the doors 12,14 and a keeper or locking bracket 66 located on the other of the doors 12,14. The locking member 64 interlocks with the keeper 66 to hold the doors 12,14 together, and can be manually released as desired. In one embodiment, the latch 60 automatically locks every time the doors 12,14 are closed, and must be manually released to open the doors 12,14. In the single-door embodiment, the latch 60 may lock the door to the window frame, rather than to another door. The lock bars 62 are shown in FIGS. 2 and 3, and provide a more secure locking arrangement, such as may be necessary to prevent burglary after business hours. As shown, each door 12,14 has a lock bar 62 hingedly attached thereto, which can be folded down to brace the door 12,14 against one of the side members 40,42 of the frame 16. These lock bars 62 can only be released from inside the window assembly 10, thus preventing opening of the doors 12,14 from outside.

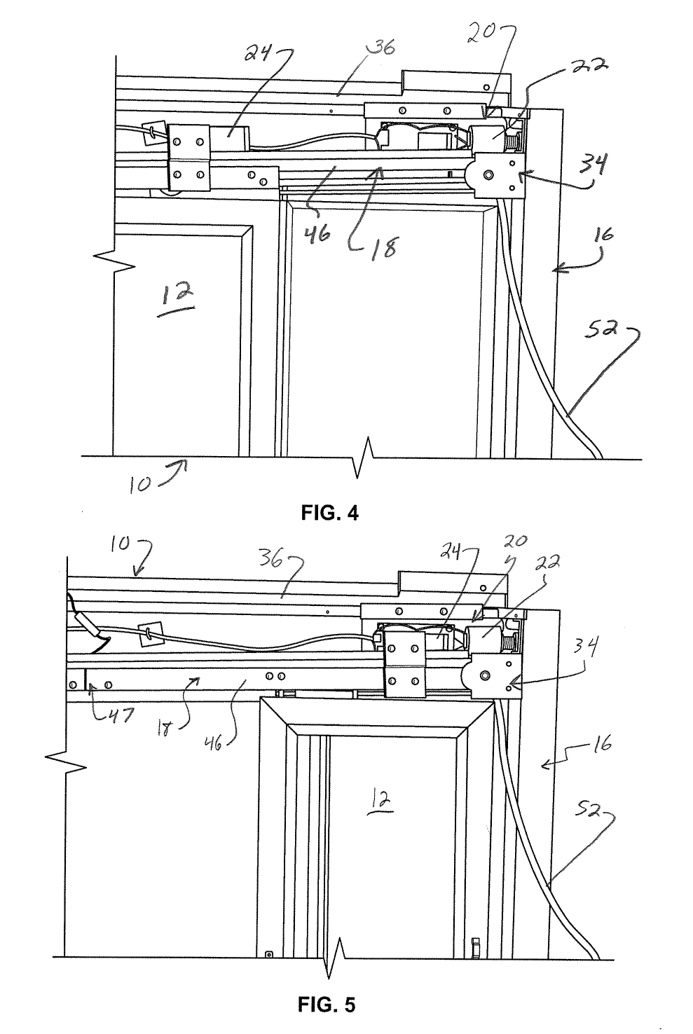

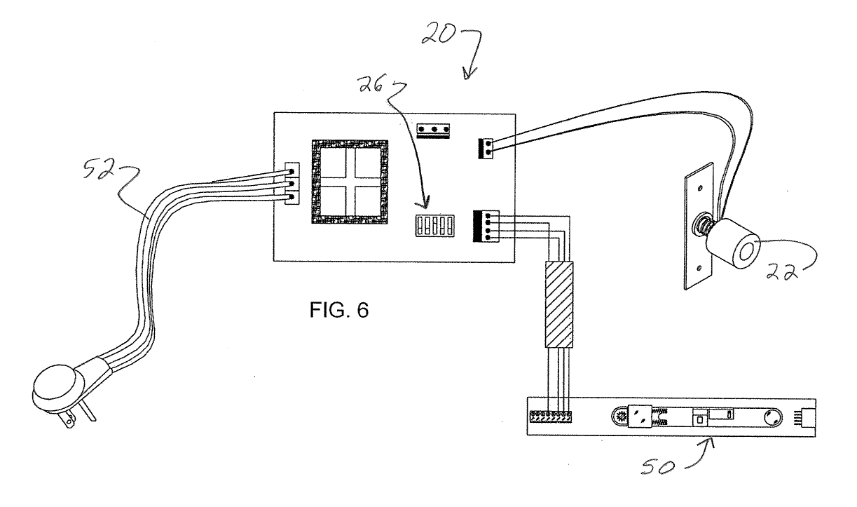

The magnet assembly 20 is shown in FIGS. 2 and 3, and illustrated in greater detail in FIGS. 4-6. The magnet assembly 20 generally includes an electrically controlled magnet 22, a magnetic contact 24, a controller 26 in communication with the magnet 22, and a power source 28 supplying electrical power to the magnet assembly 20. In one preferred embodiment, the magnet 22 is coupled to one of the first door 12 and the frame 16, and the magnetic contact 24 is connected to the other of the first door 12 and the frame 16. The magnet 22 and the magnetic contact 24 are positioned so that the magnetic contact 24 is located proximate the magnet 22, or even in contact with the magnet 22, when the first door 12 is in the open position. As shown in FIGS. 4 and 5, the magnet 22 is affixed to one of the side members 42 of the frame 16, proximate the top member 36, and the magnetic contact 24 is affixed at the top of the first door 12. It is understood that either door 12,14 could be referred to as “first,” and that the magnet 22 and magnetic contact 24 can be positioned at either the left or right side of the window assembly 10 as depicted in FIGS. 1-5. It is further understood that the magnet assembly 20 can be used with a single-door arrangement as described above, and in such an arrangement, the magnet 22 or magnetic contact 24 can be affixed to the single door. In one embodiment, the magnet 22 is a solenoid electromagnet, which can be magnetized by energizing the magnet 22, i.e. flowing an electric current therethrough, and de-magnetized by de-energizing the magnet 22, i.e. shutting off the electric current. It is understood that the magnet is of sufficient strength to hold the door. One example of a suitable electromagnet is a round island pole magnet having a holding strength of 40 lbs.

The magnetic contact 24 can generally be any magnetic or magnetizable element. The magnetic contact shown in FIGS. 4 and 5 is a block of magnetically-attractable metal, such as steel, and is affixed to the first door 12 proximate the top of the door 12. However, the contact 24 could also be a different type of magnetic or magnetizable element, such as a permanent or electrically-controllable magnet.

The controller 26 is in communication with the magnet 22 and controls the magnetization of the magnet 22 between an active state and an inactive state. In the active state, the magnet 22 is magnetized and attracts the magnetic contact 24 on the door 12, and in the inactive state, the magnet 22 is generally not magnetized, or at least not sufficiently magnetized to hold the door 12 and prevent the door 12 from closing. However, in another embodiment, the magnet 22 may be magnetized in the inactive state, but having the polarity reversed from that of the active state. Reversing the polarity of the magnet in the inactive state can be useful, for example, when a permanent magnet is used as the magnetic contact 24. Due to the positioning of the magnet 22 and the magnetic contact 24, when the magnet is in the active state and the first door 12 is in the open position, the magnet 22 and the magnetic contact 24 form a magnetic connection, securing the first door in the open position. When the magnet 22 is changed to the inactive state, the first door 12 is released, and closes automatically. Electromagnets can still retain some of their magnetism after the magnet 22 is de-energized, particularly after a long period of use, and this residual magnetism can sometimes be sufficient to hold the door 12 and prevent its release. Accordingly, in one embodiment where the magnet 22 is an electromagnet, when the magnet 22 is changed to the inactive state, the controller 26 controls the magnet 22 to be pulsed with a reverse current to briefly reverse the polarity of the magnet 22, which removes this residual magnetism and allows the door 12 to be cleanly and consistently released when the magnet 22 is de-energized. However, in another embodiment, the magnet 22 is controlled to the inactive state simply by de-energizing the magnet 22.

The controller 26 can be any suitable control device. In one exemplary embodiment, the controller 26 contains a microprocessor that receives input from the sensor 50 and controls the magnet 22 to hold open the door 12 for a predetermined time set by DIP switches on the circuit board (PCB). If the controller 26 is configured to pulse the magnet 22 with reverse current, as described above, the microprocessor controls the output of two power transistors for that purpose. It is understood that the controller 26 may be integrated into one of the other components of the window assembly 10, such as the magnet 22 or the sensor 50.

The sensor 50 is mounted on or near the window assembly 10 and is adapted to detect the presence (or absence) of a user near the window assembly 10. A user is generally a person who is conducting business or otherwise using the window assembly 10 for a task or activity. As shown in FIG. 1, the sensor 50 is mounted on the top member 36 of the window frame 16, allowing the sensor 50 to detect whether an entity (such as a user) is positioned between the sensor 50 and the floor proximate the window assembly 10. The area between the sensor 50 and the floor proximate the window assembly 10 is referred to herein as a detection area. In one embodiment, the sensor 50 uses infrared (IR) or other reflectable energy waves for this purpose. The sensor 50 may further be modified and adjusted to change the size of the detection area. For example, the sensor may be pivotable to adjust the size and/or position of the detection area. In this embodiment, the sensor 50 pointing directly downward would detect a user directly in front of the doors 12,14, but if the sensor 50 is pivoted to angle farther outward from the doors 12,14, the detection area would be increased, or at least moved farther from the doors 12,14. Accordingly, the sensor 50, and the size and position of the detection area, can be adjusted as desired by the user or owner.

The sensor 50 is in communication with the controller 26 and the magnet 22. Generally, when the sensor 50 detects that the user is present, the magnet 22 is placed in the active state and when the sensor 50 detects that the user is not present, the magnet 22 is placed in the inactive state. In one embodiment, the controller 26 receives an input from the sensor 50 and control the magnetization of the magnet 22 accordingly. In some embodiments, a sensor 50 may not be present, and the controller 26 may control the magnet 22 in response to different input, such as manual actuation.

A power source 52 is coupled to the magnet 22, the controller 26, and the sensor 50, and can supply electrical current to any or all of the three. The power source 52 is generally connected to the components of the window assembly 1 0 through an electrical cord and wires and a three prong plug. The power source 52 provides the electrical current to magnetize the magnet 22 when appropriate. The controller 26 controls electrical current from the power source to the magnet to control the magnet between the active state and the inactive state.

The assembly and operation of the embodiment of the window assembly 10 illustrated in FIGS. 1-6 is described in detail below. The window assembly 10 is generally adapted to be placed within an interior or exterior wall, allowing a user to access people or objects through the wall. To accomplish this, the window frame 16 is secured within an opening in the wall. The track 18 is affixed to the top member 36 of the window frame 18 with the arms 46,48 angling downward toward the center point 47, as described above. The doors 12,14 are then mounted within the frame 18 by slidably mounting the doors 12,14 on the track 18 by means of the roller assemblies 44. The pulley assembly 34 is also connected to both doors 12,14 and the frame 16 along the top frame member 36. The magnet 22 is connected to one of the side members 42 of the frame 16, and the magnetic contact 24 is affixed to the top end of the first door 12. It is understood, as described above, that this orientation of the magnet 22 and the contact 24 may be reversed. The sensor 50 is mounted along the top member 36 of the frame 16, directly above the center point 47 of the track 18. The sensor 50 is then wired to the magnet 22 through the controller 26, and the power supply 52 is connected to these components.

The embodiment of the window assembly 10 shown in FIGS. 1-6 is designed to be operated by a user on one side of the window assembly 10. By default, the doors 12,14 are in the closed positions, due to the biasing imparted by the inclined track 18. To open the doors 12,14, the user manually pulls one or both of the doors 12,14 to the open position. In the embodiment shown, the user need only pull one of the doors 12,14 to the open position, since the pulley assembly 34 will move the other door 12,14 in unison with the moving door 12,14. If the latch 60 and/or the lock bars 62 are engaged, the user will have to disengage the mechanism(s) before opening the doors 12,14. Generally, as the user opens the doors 12,14, the user will be in the detection area of the sensor 50. The sensor 50 will detect the presence of the user, and in response, the controller 26 will control the magnet 22 to the active state by energizing the magnet 22. Once the first door 12 is fully open, the active (magnetized) magnet 22 will attract the magnetic contact 24, creating a magnetic connection between the magnet 22 and the contact 24 and exerting a retaining force upon the contact 24. This retaining force is sufficient to offset the gravitational biasing force imparted by the inclined track 18, and thus, the first door 12 is retained in the open position by the magnet 22. When the first door 12 is retained in the open position, the pulley assembly 34 also retains the second door 14 in the open position. Once the user steps away from the window, leaving the detection area of the sensor 50, the sensor 50 will detect that the user is not present, and the controller 26 will respond by returning the magnet 22 to the inactive state, by briefly reverse- pulsing and then de-energizing the magnet 22 as described above. This releases the magnetic connection between the magnet 22 and the magnetic contact, which eliminates the retaining force on the door 12, and the gravitational biasing force returns the doors 12,14 to the closed positions. The controller 26 may be configured to delay changing the magnet 22 to the inactive state for a pre-set time period after the sensor 50 detects that the user is not present. This configuration permits the user to briefly leave and re-enter the detection area without creating the need to re-open the door, such as to quickly grab an ordered item or condiment package. In other embodiments, the window assembly 10 may be designed to allow for operation by users on either or both sides of the window assembly 10.

The window assembly 10 provides many benefits and advantages. The window assembly 10 can be used in a variety of applications, for example, as a service window for a drive-through service at a restaurant, grocery store, pharmacy, or other business. When a user opens the window assembly 10 to perform an action, such as servicing a customer, the window will remain open for as long as the user remains at the window. This allows the user to perform actions using both hands, and other positioning that would cause difficulties in holding the window open. Once the user leaves the window, such as when a transaction has been completed, the window will close automatically, which is desirable for many reasons, such as keeping insects and pollutants out and controlling the interior temperature of the establishment. The window assembly uses less electricity than windows with opening and/or closing mechanisms, since electricity is only used to operate the sensor and to hold the window open. Further, the window assembly is lower-profile, using more glass and less metal than prior window assemblies. Still other benefits and advantages are provided.

While the specific embodiments have been illustrated and described, numerous modifications come to mind without significantly departing from the spirit of the invention, and the scope of protection is only limited by the scope of the accompanying Claims. Terms such as “first,” “second,” “left,” “right,” “top,” “bottom,” etc., are used for reference purposes only, and are not intended to limit the invention.

What is claimed is:

1. A service window assembly comprising:
a window frame;
a first door mounted in the frame, the door being moveable between an open position and a closed position;
an electrically controlled magnet connected to one of the frame and the door;
a magnetic contact connected to the other of the frame and the door wherein the magnetic contact is located proximate the magnet when the door is in the open position; and
a controller in communication with the magnet, the controller controlling the magnetization of the magnet between an active state and an inactive state, wherein when the magnet is in the active state and the door is in the open position, the magnet and the magnetic contact form a magnetic connection, securing the door in the open position.

2. The service window assembly of claim 1, further comprising a second door mounted in the frame and moveable between an open position and a closed position.

3. The service window assembly of claim 2, wherein the second door is operably connected to the first door such that the first door and the second door move in unison between the respective open and closed positions.

4. The service window assembly of claim 3, further comprising a pulley assembly operably connecting the first door and the second door, wherein the pulley assembly moves the first door and the second door in unison between the respective open and closed positions.

5. The service window assembly of claim 1, further comprising an inclined track attached to the frame, wherein the first door is slidably coupled to the inclined track, and wherein the inclined track is inclined to gravitationally bias the door toward the closed position.

6. The service window assembly of claim 5, wherein the first door is coupled to the inclined track by a roller assembly.

7. The service window assembly of claim 1, further comprising a power source in electrical connection with the magnet, wherein the magnet is an electromagnet, and wherein the controller controls electrical current from the power source to the magnet to control the magnet between the active state and the inactive state.

8. The service window assembly of claim 1, further comprising a sensor connected to the window assembly to monitor the presence of a user.

9. The service window assembly of claim 8, wherein the sensor is in communication with the controller, and wherein the controller controls the magnet to the active state when the sensor detects that the user is present, and the controller controls the magnet to the inactive state when the sensor detects that the user is not present.

10. The service window assembly of claim 1, further comprising a latch attached to the door, the latch allowing a user to secure the door in the closed position.

11. The service window assembly of claim 1, wherein the magnet is connected to the door and the magnetic contact is connected to the frame.

12. A service window assembly comprising:
a window frame;
a first door slidably mounted within the frame by a roller assembly, the door being moveable between an open position and a closed position, wherein the door is biased toward the closed position;
an electrically controlled magnet connected to one of the frame and the door, the magnet operable in an active state and an inactive state;
a magnetic contact connected to the other of the frame and the door wherein the magnetic contact is located proximate the magnet when the door is in the open position, and wherein when the magnet is in the active state and the door is in the open position, the magnet and the magnetic contact form a magnetic connection, securing the door in the open position; and, a sensor connected to the window assembly to monitor the presence of a user, the sensor in communication with the magnet, wherein the magnet is in the active state when the sensor detects that the user is present, and the magnet is in the inactive state when the sensor detects that the user is not present.

13. The service window assembly of claim 12, further comprising a second door slidably mounted within the frame by a second roller assembly, the second door being moveable between an open position and a closed position, wherein the second door is biased toward the closed position and the first door and the second door move in opposing directions.

14. The service window assembly of claim 13, wherein the second door is operably connected to the first door such that the first door and the second door move in unison between the respective open and closed positions.

15. The service window assembly of claim 14, further comprising a pulley assembly operably connecting the first door and the second door, wherein the pulley assembly moves the first door and the second door in unison between the respective open and closed positions.

16. The service window assembly of claim 12, wherein the roller assembly comprises a roller coupled to an inclined track, the roller attached to the door and the inclined track attached to the frame.

17. The service window assembly of claim 12, further comprising a power source in electrical connection with the magnet, wherein the magnet is an electromagnet, and wherein the electrical current from the power source to the magnet controls the magnet between the active state and the inactive state.

18. The service window assembly of claim 12, further comprising a controller in communication with the magnet and the sensor, wherein the controller controls the magnetization of the magnet to the active state in response to the sensor detecting that the user is present and to the inactive state in response to the sensor detecting that the user is not present.

19. A service window assembly comprising:
a window frame;
a first door slidably mounted within the frame by a first roller assembly, the first door being moveable between an open position and a closed position;
a second door slidably mounted within the frame by a second roller assembly, the second door being moveable between an open position and a closed position, wherein the first door and the second door move in opposing directions between the respective open and closed positions;
an inclined track attached to the frame, comprising a first arm and a second arm extending in opposite directions from a center point, the first door coupled to the first arm by the first roller assembly and the second door coupled to the second arm by the second roller assembly, wherein the first arm and second arm are inclined downwardly toward the center point to gravitationally bias the first door and the second door toward the closed positions;
a pulley assembly operably connecting the first door and the second door, wherein the pulley assembly moves the first door and the second door in unison between the respective open and closed positions;
an electrically controlled magnet coupled to one of the first door and the frame;
a magnetic contact connected to the other of the first door and the frame wherein the magnetic contact is located proximate the magnet when the first door is in the open position;
a controller in communication with the magnet, the controller controlling the magnetization of the magnet between an active state and an inactive state, wherein when the magnet is in the active state and the first door is in the open position, the magnet and the magnetic contact form a magnetic connection, securing the first door in the open position;
a sensor connected to the window assembly to monitor the presence of a user, the sensor in communication with the controller, wherein the controller controls the magnet to the active state when the sensor detects that the user is present, and the controller controls the magnet to the inactive state when the sensor detects that the user is not present.

20. The service window assembly of claim 19 further comprising a power source in electrical connection with the magnet, wherein the magnet is an electromagnet, and wherein the controller controls electrical current from the power source to the magnet to control the magnet between the active state and the inactive state.
